(19) United States
(12) Patent Application Publication
(10) Pub. No.: US 2007/0157232 A1
(43) Pub. Date: Jul. 5, 2007

(54) User interface with software lensing

(76) Inventors: Randy R. Dunton, Phoenix, AZ (US); John J. Light, Beaverton, OR (US); Lincoln D. Wilde, Portland, OR (US); Brian V. Belmont, West Linn, OR (US); Dale Herigstad, Los Angeles, CA (US); Jason Brush, Los Angeles, CA (US); Carol Soh, Los Angeles, CA (US)

Correspondence Address: KACVINSKY LLC;C/O INTELLEVATE, P.O. BOX 52050, MINNEAPOLIS, MN, 55402, US

(21) Appl. No.: 11/322,580

(22) Filed: Dec. 30, 2005

(51) Int. Cl. H04N 5/445; G06F 3/00; G06F 13/00

(52) U.S. Cl. 725/37; 725/39

(57) ABSTRACT

A user interface with software lensing may be described. An apparatus may comprise a user interface module to display information objects for an electronic program guide, receive movement information from a remote control, and move a pointer in response to the movement information. The apparatus may further include a media lensing module to increase a first information object to a first size when the pointer approaches or coincides with the first information object. Other embodiments are described and claimed.

### RELATED APPLICATIONS

This application is a related to a commonly owned U.S. patent application Ser. No. ______ titled “A User Interface For A Media Device” and filed on Dec. 30, 2005, and a commonly owned U.S. patent application Ser. No. ______ titled “Techniques For Generating Information Using A Remote Control” and filed on Dec. 30, 2005, which are both incorporated herein by reference.

### BACKGROUND

Consumer electronics and processing systems are converging. Consumer electronics such as televisions and media centers are evolving to include processing capabilities typically found on a computer. The increase in processing capabilities may allow consumer electronics to execute more sophisticated system and application programs. Such programs typically require robust user interfaces, capable of displaying and navigating through ever increasing amounts of information. Accordingly, there may be a need for improved techniques to solve these and other problems.

### BRIEF DESCRIPTION OF THE DRAWINGS

FIG. 1 illustrates one embodiment of a media processing system.

FIG. 2 illustrates one embodiment of a media processing sub-system.

FIG. 3 illustrates one embodiment of a first user interface display.

FIG. 4 illustrates one embodiment of a second user interface display in a first view.

FIG. 5 illustrates one embodiment of a second user interface display in a second view.

FIG. 6 illustrates one embodiment of a second user interface display in a third view.

FIG. 7 illustrates one embodiment of a first logic flow.

FIG. 8 illustrates one embodiment of a third user interface display.

FIG. 9 illustrates one embodiment of a fourth user interface display in a first view.

FIG. 10 illustrates one embodiment of a fourth user interface display in a second view.

### DETAILED DESCRIPTION

Various embodiments may be directed to a user interface utilizing various software lensing techniques for a media device having a display. The software lensing techniques may be used for various applications. For example, the software lensing techniques may be used to navigate through an electronic program guide. In another example, the software lensing techniques may be used to navigate through various sets of graphical objects, such as found in a picture archive or video archive. Other embodiments are described and claimed.

Various embodiments may include a user interface arranged to accept user input from a remote control. For example, the user interface module may be arranged to receive movement information representing pointing movements of the remote control. The remote control may be arranged to provide movement information as a user moves the remote control through space, such as moving the remote control to point to different objects displayed on a screen. In this manner, a user may enter information into a media device such as a television or set top box using the remote control as an “air” mouse. Alternatively, a user may provide movement information to the user interface module using other pointing devices implemented as either separate from the remote control or integrated with the remote control. The embodiments are not limited in this context.

In various embodiments, the user interface may be used to navigate through an electronic program guide. In one embodiment, for example, the user interface module may display information objects for the electronic program guide. Examples of information objects may include any type of media information, such as alphanumeric text, symbols, images, graphics, and so forth. The user interface module may receive movement information from the remote control, and move a pointer or cursor in response to the movement information. A media lensing module may use software lensing techniques to increase a size for an information object when the pointer approaches or coincides with the information object. Other embodiments are described and claimed.

In various embodiments, the user interface may be used to navigate through various sets of graphical objects, such as found in a picture archive or video archive. In one embodiment, for example, the user interface module may receive movement information from the remote control, and move a pointer in response to the movement information. The user interface module may display a first set of graphical objects of a first size in a first area. The user interface module may display a second set of graphical objects of a second size in a second area when the pointer approaches or coincides with the first area. The second set of graphical objects may include a sub-set from the first set of graphical objects. The second size for the second set of graphical objects may be greater than the first size for the first set of graphical objects. A media lensing module may use software lensing techniques to increase a first graphical object of the second set of graphical objects to a third size when a pointer approaches or coincides with the first graphical object in the second area. The third size for the first graphical object may be greater than the second size for the second set of graphical objects. Other embodiments are described and claimed.

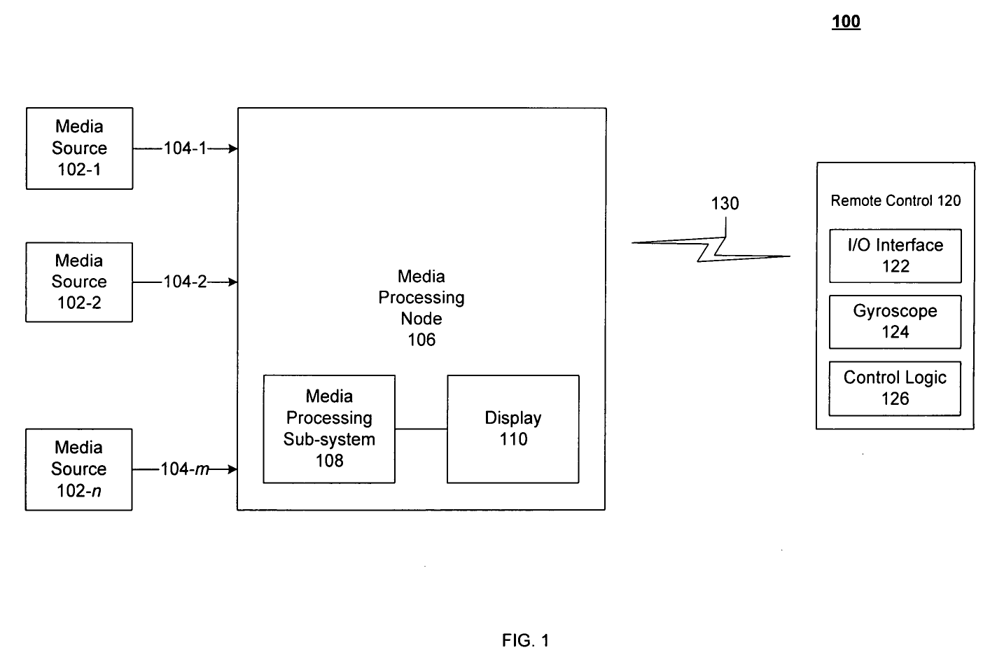

FIG. 1 illustrates one embodiment of a media processing system. FIG. 1 illustrates a block diagram of a media processing system 100. In one embodiment, for example, media processing system 100 may include multiple nodes. A node may comprise any physical or logical entity for processing and/or communicating information in the system 100 and may be implemented as hardware, software, or any combination thereof, as desired for a given set of design parameters or performance constraints. Although FIG. 1 is shown with a limited number of nodes in a certain topology, it may be appreciated that system 100 may include more or less nodes in any type of topology as desired for a given implementation. The embodiments are not limited in this context.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a television, a digital television, a set top box (STB), a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a processor, and so forth. The embodiments are not limited in this context.

In various embodiments, media processing system 100 may communicate, manage, or process information in accordance with one or more protocols. A protocol may comprise a set of predefined rules or instructions for managing communication among nodes. A protocol may be defined by one or more standards as promulgated by a standards organization, such as, the International Telecommunications Union (ITU), the International Organization for Standardization (ISO), the International Electrotechnical Commission (IEC), the Institute of Electrical and Electronics Engineers (IEEE), the Internet Engineering Task Force (IETF), the Motion Picture Experts Group (MPEG), and so forth. For example, the described embodiments may be arranged to operate in accordance with standards for media processing, such as the National Television Systems Committee (NTSC) standard, the Advanced Television Systems Committee (ATSC) standard, the Phase Alteration by Line (PAL) standard, the MPEG- 1 standard, the MPEG-2 standard, the MPEG-4 standard, the Digital Video Broadcasting Terrestrial (DVB-T) broadcasting standard, the DVB Satellite (DVB-S) broadcasting standard, the DVB Cable (DVB-C) broadcasting standard, the Open Cable standard, the Society of Motion Picture and Television Engineers (SMPTE) Video-Codec (VC-1) standard, the ITU/IEC H.263 standard, Video Coding for Low Bitrate Communication, ITU-T Recommendation H.263v3, published November 2000 and/or the ITU/IEC H.264 standard, Video Coding for Very Low Bit Rate Communication, ITU-T Recommendation H.264, published May 2003, and so forth. The embodiments are not limited in this context.

In various embodiments, the nodes of media processing system 100 may be arranged to communicate, manage or process different types of information, such as media information and control information. Examples of media information may generally include any data or signals representing content meant for a user, such as media content, voice information, video information, audio information, image information, textual information, numerical information, alphanumeric symbols, graphics, and so forth. Control information may refer to any data or signals representing commands, instructions or control words meant for an automated system. For example, control information may be used to route media information through a system, to establish a connection between devices, instruct a node to process the media information in a predetermined manner, monitor or communicate status, perform synchronization, and so forth. The embodiments are not limited in this context.

In various embodiments, media processing system 100 may be implemented as a wired communication system, a wireless communication system, or a combination of both. Although media processing system 100 may be illustrated using a particular communications media by way of example, it may be appreciated that the principles and techniques discussed herein may be implemented using any type of communication media and accompanying technology. The embodiments are not limited in this context.

When implemented as a wired system, for example, media processing system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The wired communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, media processing system 100 may include one or more wireless nodes arranged to communicate information over one or more types of wireless communication media. An example of wireless communication media may include portions of a wireless spectrum, such as the RF spectrum. The wireless nodes may include components and interfaces suitable for communicating information signals over the designated wireless spectrum, such as one or more antennas, wireless transmitters, receiver, transmitters/receivers (“transceivers”), amplifiers, filters, control logic, antennas, and so forth. The embodiments are not limited in this context.

In various embodiments, media processing system 100 may include one or more media source nodes 102-1-n. Media source nodes 102-1-n may comprise any media source capable of sourcing or delivering media information and/or control information to media processing node 106. More particularly, media source nodes 102-1-n may comprise any media source capable of sourcing or delivering digital audio and/or video (AV) signals to media processing node 106. Examples of media source nodes 102-1-n may include any hardware or software element capable of storing and/or delivering media information, such as a DVD device, a VHS device, a digital VHS device, a personal video recorder, a computer, a gaming console, a Compact Disc (CD) player, computer-readable or machine-readable memory, a digital camera, camcorder, video surveillance system, teleconferencing system, telephone system, medical and measuring instruments, scanner system, copier system, television system, digital television system, set top boxes, personal video records, server systems, computer systems, personal computer systems, digital audio devices (e.g., MP3 players), and so forth. Other examples of media source nodes 102-1-n may include media distribution systems to provide broadcast or streaming analog or digital AV signals to media processing node 106. Examples of media distribution systems may include, for example, Over The Air (OTA) broadcast systems, terrestrial cable systems (CATV), satellite broadcast systems, and so forth. It is worthy to note that media source nodes 102-1-n may be internal or external to media processing node 106, depending upon a given implementation. The embodiments are not limited in this context.

In various embodiments, media processing system 100 may comprise a media processing node 106 to connect to media source nodes 102-1-n over one or more communications media 104-1-m. Media processing node 106 may comprise any node as previously described that is arranged to process media information received from media source nodes 102-1-n. In various embodiments, media processing node 106 may comprise, or be implemented as, one or more media processing devices having a processing system, a processing sub-system, a processor, a computer, a device, an encoder, a decoder, a coder/decoder (codec), a filtering device (e.g., graphic scaling device, deblocking filtering device), a transformation device, an entertainment system, a display, or any other processing architecture. The embodiments are not limited in this context.

In various embodiments, media processing node 106 may include a media processing sub-system 108. Media processing sub-system 108 may comprise a processor, memory, and application hardware and/or software arranged to process media information received from media source nodes 102-1-n. For example, media processing sub-system 108 may be arranged to perform various media operations and user interface operations as described in more detail below. Media processing sub-system 108 may output the processed media information to a display 110. The embodiments are not limited in this context.

In various embodiments, media processing node 106 may include a display 110. Display 10 may be any display capable of displaying media information received from media source nodes 102-1-n. Display 110 may display the media information at a given format resolution. In various embodiments, for example, the incoming video signals received from media source nodes 102-1-n may have a native format, sometimes referred to as a visual resolution format. Examples of a visual resolution format include a digital television (DTV) format, high definition television (HDTV), progressive format, computer display formats, and so forth. For example, the media information may be encoded with a vertical resolution format ranging between 480 visible lines per frame to 1080 visible lines per frame, and a horizontal resolution format ranging between 640 visible pixels per line to 1920 visible pixels per line. In one embodiment, for example, the media information may be encoded in an HDTV video signal having a visual resolution format of 720 progressive (720p), which refers to 720 vertical pixels and 1280 horizontal pixels (720×1280). In another example, the media information may have a visual resolution format corresponding to various computer display formats, such as a video graphics array (VGA) format resolution (640×480), an extended graphics array (XGA) format resolution (1024×768), a super XGA (SXGA) format resolution (1280×1024), an ultra XGA (UXGA) format resolution (1600×1200), and so forth. The embodiments are not limited in this context. The type of displays and format resolutions may vary in accordance with a given set of design or performance constraints, and the embodiments are not limited in this context.

In general operation, media processing node 106 may receive media information from one or more of media source nodes 102-1-n. For example, media processing node 106 may receive media information from a media source node 102-1 implemented as a DVD player integrated with media processing node 106. Media processing sub-system 108 may retrieve the media information from the DVD player, convert the media information from the visual resolution format to the display resolution format of display 110, and reproduce the media information using display 110.

Electronic Program Guide Navigation

To facilitate operations, media processing sub-system 108 may include a user interface module to provide software lensing and remote user input. Software lensing may refer to techniques for increasing, enlarging, or magnifying an area when a pointer or cursor coincides or approaches the area. This may be accomplished in real time with reduced delay, rather than by selection or loitering over a given area for a certain amount of time as in conventional techniques. Although software lensing is typically implemented in software, it may be appreciated that all or portions of the software lensing technique may be performed by software, hardware, or a combination of both. The embodiments are not limited in this context.

In various embodiments, the user interface module may allow a user to control certain operations of media processing node 106, such as various system programs or application programs. For example, assume media processing node 106 comprises a television that has access to an electronic program guide. The electronic program guide may allow a user to view program listings, navigate content, select a program to view, record a program, and so forth. Similar, a media source node 102-1-n may include menu programs to provide user options in viewing or listening to media content reproduced or provided by media source node 102-1-n, and may display the menu options via display 110 of media processing node 106 (e.g., a television display). The user interface module may display user options to a viewer on display 10 in the form of a graphic user interface (GUI), for example. In such cases, a remote control is typically used to navigate through such basic options.

Consumer electronics such as televisions and media centers, however, are evolving to include processing capabilities typically found on a computer. The increase in processing capabilities may allow consumer electronics to execute more sophisticated system and application programs. Such programs typically require robust user interfaces, capable of displaying and navigating through ever increasing amounts of information.

In the case of a digital television or a set top box, for example, an electronic program guide may present to a viewer a large number of network channels, programs or program information. With the advent of multiple broadcast sources as well as Internet based video content, the number of channels is increasing by orders of magnitude. As a result, the electronic program guide may need to show a viewer an increasing amount of information. Conventional techniques such as scrolling, paging or indexing techniques may cause a viewer to become lost in the information, thereby decreasing user satisfaction.

Various embodiments may solve these and other problems. In various embodiments, media processing sub-system 108 may include a user interface module that may be used to navigate through an electronic program guide for various media devices, such as media source nodes 102-1-n and/or media processing node 106. In one embodiment, for example, the user interface module may display information objects for the electronic program guide. The information objects may display media information or control information as previously described. The user interface module may receive movement information from a remote control, and move a pointer or cursor in response to the movement information. The user interface module may include a media lensing module. The media lensing module may use various software lensing techniques to increase, enlarge or magnify a size for an information object when the pointer coincides with the information object, or alternatively, approaches the information object. In the latter case, a predefined distance from the information object may be defined as desired for a given implementation, and the embodiments are not limited in this respect.

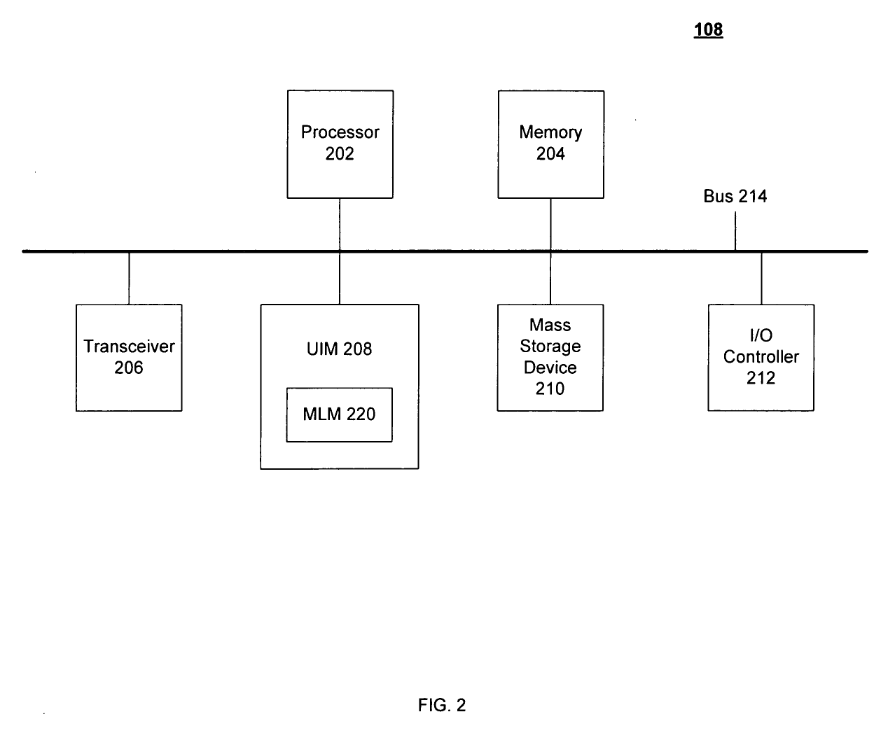

In various embodiments, the user interface module of media processing sub-system 108 may be arranged to accept user input from a remote control 120. Remote control 120 may be arranged to control, manage or operate media processing node 106 by communicating control information using infrared (IR) or radio-frequency (RF) signals. In one embodiment, for example, remote control 120 may include one or more light-emitting diodes (LED) to generate the infrared signals. The carrier frequency and data rate of such infrared signals may vary according to a given implementation. An infrared remote control may typically send the control information in a low-speed burst, typically for distances of approximately 30 feet or more. In another embodiment, for example, remote control 120 may include an RF transceiver. The RF transceiver may match the RF transceiver used by media processing sub-system 108, as discussed in more detail with reference to FIG. 2. An RF remote control typically has a greater distance than an IR remote control, and may also have the added benefits of greater bandwidth and removing the need for line-of-sight operations. For example, an RF remote control may be used to access devices behind objects such as cabinet doors.

Remote control 120 may control operations for media processing node 106 by communicating control information to media processing node 106. The control information may include one or more IR or RF remote control command codes (“command codes”) corresponding to various operations that the device is capable of performing. The command codes may be assigned to one or more keys or buttons included with an I/O device 122 for remote control 120. I/O device 122 of remote control 120 may comprise various hardware or software buttons, switches, controls or toggles to accept user commands. For example, I/O device 122 may include a numeric keypad, arrow buttons, selection buttons, power buttons, mode buttons, selection buttons, menu buttons, and other controls needed to perform the normal control operations typically found in conventional remote controls. There are many different types of coding systems and command codes, and generally different manufacturers may use different command codes for controlling a given device.

In addition to I/O device 122, remote control 120 may also include elements that allow a user to enter information into a user interface at a distance by moving the remote control through the air in two or three dimensional space. For example, remote control 120 may include a gyroscope 124 and control logic 126. Gyroscope 124 may comprise a gyroscope typically used for pointing devices, remote controls and game controllers. For example, gyroscope 124 may comprise a miniature optical spin gyroscope. Gyroscope 124 may be an inertial sensor arranged to detect natural hand motions to move a cursor or graphic on display 110, such as a television screen or computer monitor. Gyroscope 124 and control logic 126 may be components for an “In Air” motion-sensing technology that can measure the angle and speed of deviation to move a cursor or other indicator between Point A and Point B, allowing users to select content or enable features on a device waving or pointing remote control 120 in the air. In this arrangement, remote control 120 may be used for various applications, to include providing device control, content indexing, computer pointers, game controllers, content navigation and distribution to fixed and mobile components through a single, hand-held user interface device.

Although some embodiments are described with remote control 120 using a gyroscope 124 by way of example, it may be appreciated that other free-space pointing devices may also be used with remote control 120 or in lieu of remote control 120. For example, some embodiments may use a free-space pointing device made by Hillcrest Labs™ for use with the Welcome HoME™ system, a media center remote control such as WavIt MC™ made by ThinkOptics, Inc., a game controller such as Wavlt XT™ made by ThinkOptics, Inc., a business presenter such as Wavlt XB™ made by ThinkOptics, Inc., free-space pointing devices using accelerometers, and so forth. The embodiments are not limited in this context.

In one embodiment, for example, gyroscope 124 and control logic 126 may be implemented using the MG1101 and accompanying software and controllers as made by Thomson's Gyration, Inc., Saratoga, Calif. The MG1101 is a dual-axis miniature rate gyroscope that is self-contained for integration into human input devices such as remote control 120. The MG 101 has a tri-axial vibratory structure that isolates the vibrating elements to decrease potential drift and improve shock resistance. The MG1101 can be mounted directly to a printed circuit board without additional shock mounting. The MG1101 uses an electromagnetic transducer design and a single etched beam structure that utilizes the “Coriolis Effect” to sense rotation in two axes simultaneously. The MG1101 includes an integrated analog-to-digital converter (ADC) and communicates via a conventional 2-wire serial interface bus allowing the MG1101 to connect directly to a microcontroller with no additional hardware. The MG 1101 further includes memory, such as 1 K of available EEPROM storage on board, for example. Although the MG1101 is provided by way of example, other gyroscope technology may be implemented for gyroscope 124 and control logic 126 as desired for a given implementation. The embodiments are not limited in this context.

In operation, a user may use remote control 120 to provide information for the user interface module at a distance by moving remote control 120 through the air, similar to an air mouse. For example, a user may point remote control 120 to various objects displayed on display 110. Gyroscope 124 may sense the movements of remote control 120, and send movement information representing the movements to media processing node 106 over wireless communications media 130. The user interface module of media processing sub-system 108 may receive the movement information, and move a pointer (e.g., mouse pointer) or cursor in accordance with the movement information on display 110. The user interface module may use the movement information and associated selection commands to perform any number of user defined operations for media source nodes 102-1-n and/or media source node 106, such as navigating an electronic program guide, selecting options, searching for media content, selecting media objects, and so forth.

In addition to operating as an air mouse or pointing device using gyroscope 124 and control logic 126, remote control 120 may use other techniques to control a pointer. For example, remote control 120 may include an integrated pointing device. The pointing device may include various types of pointer controls, such as a track or roller ball, a pointing stick or nub, a joystick, arrow keys, direction keys, and so forth. Integrating a pointing device with remote control 120 may facilitate pointing operations for a user. Alternatively, a user may use a pointing device separate from remote control 120, such as various different types of mice or controllers. The pointing device may also be part of another device other than remote control 120, such as a wired or wireless keyboard. The particular implementation for the pointing device may vary as long as the pointing device provides movement information for the user interface module and allows a user to generate the movement information from a distance (e.g., normal viewing distance). The embodiments are not limited in this context.

FIG. 2 illustrates one embodiment of a media processing sub-system 108. FIG. 2 illustrates a block diagram of a media processing sub-system 108 suitable for use with media processing node 106 as described with reference to FIG. 1. The embodiments are not limited, however, to the example given in FIG. 2.

As shown in FIG. 2, media processing sub-system 108 may comprise multiple elements. One or more elements may be implemented using one or more circuits, components, registers, processors, software subroutines, modules, or any combination thereof, as desired for a given set of design or performance constraints. Although FIG. 2 shows a limited number of elements in a certain topology by way of example, it can be appreciated that more or less elements in any suitable topology may be used in media processing sub-system 108 as desired for a given implementation. The embodiments are not limited in this context.

In various embodiments, media processing sub-system 108 may include a processor 202. Processor 202 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, processor 202 may be implemented as a general purpose processor, such as a processor made by Intel® Corporation, Santa Clara, Calif. Processor 202 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments are not limited in this context.

In one embodiment, media processing sub-system 108 may include a memory 204 to couple to processor 202. Memory 204 may be coupled to processor 202 via communications bus 214, or by a dedicated communications bus between processor 202 and memory 204, as desired for a given implementation. Memory 204 may be implemented using any machine-readable or computer-readable media capable of storing data, including both volatile and non-volatile memory. For example, memory 204 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 204 may be included on the same integrated circuit as processor 202, or alternatively some portion or all of memory 204 may be disposed on an integrated circuit or other medium, for example a hard disk drive, that is external to the integrated circuit of processor 202. The embodiments are not limited in this context.

In various embodiments, media processing sub-system 108 may include a transceiver 206. Transceiver 206 may be any infrared or radio transmitter and/or receiver arranged to operate in accordance with a desired set of wireless protocols. Examples of suitable wireless protocols may include various wireless local area network (WLAN) protocols, including the IEEE 802.xx series of protocols, such as IEEE 802.11a/b/g/n, IEEE 802.16, IEEE 802.20, and so forth. Other examples of wireless protocols may include various wireless wide area network (WWAN) protocols, such as Global System for Mobile Communications (GSM) cellular radiotelephone system protocols with General Packet Radio Service (GPRS), Code Division Multiple Access (CDMA) cellular radiotelephone communication systems with 1×RTT, Enhanced Data Rates for Global Evolution (EDGE) systems, and so forth. Further examples of wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles (collectively referred to herein as “Bluetooth Specification”), and so forth. Other suitable protocols may include Ultra Wide Band (UWB), Digital Office (DO), Digital Home, Trusted Platform Module (TPM), ZigBee, and other protocols. The embodiments are not limited in this context.

In various embodiments, media processing sub-system 108 may include one or more modules. The modules may comprise, or be implemented as, one or more systems, sub-systems, processors, devices, machines, tools, components, circuits, registers, applications, programs, subroutines, or any combination thereof, as desired for a given set of design or performance constraints. The embodiments are not limited in this context.

In various embodiments, media processing sub-system 108 may include a MSD210. Examples of MSD210 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, media processing sub-system 108 may include one or more I/O adapters 212. Examples of I/O adapters 212 may include Universal Serial Bus (USB) ports/adapters, IEEE 1394 Firewire ports/adapters, and so forth. The embodiments are not limited in this context.

In one embodiment, for example, media processing sub-system 108 may include various application programs, such as a user interface module (UIM) 208. For example, UIM 208 may comprise a GUI to communicate information between a user and media processing sub-system 108. Media processing sub-system 108 may also include system programs. System programs assists in the running of a computer system. System programs may be directly responsible for controlling, integrating, and managing the individual hardware components of the computer system. Examples of system programs may include operating systems (OS), device drivers, programming tools, utility programs, software libraries, interfaces, program interfaces, API, and so forth. It may be appreciated that UIM 208 may be implemented as software executed by processor 202, dedicated hardware such as a media processor or circuit, or a combination of both. The embodiments are not limited in this context.

In various embodiments, UIM 208 may be arranged to receive user input via remote control 120. Remote control 120 may be arranged to allow a user to perform pointing operations similar to a mouse or other pointing device using gyroscope 124. UIM 208 and remote control 120 allow a user to control a pointer on display 110 even when situated a relatively far distance from display 110, such as normal viewing distance (e.g., 10 feet or more), and without the need for typical wired connections.

In various embodiments, UIM 208 of media processing sub-system 108 may be used to navigate through an electronic program guide for media source nodes 102-1-n and/or media processing node 106. In one embodiment, for example, UIM 208 may display various information objects for the electronic program guide. UIM 208 may receive movement information from a remote control, and move a pointer in response to the movement information on display 110.

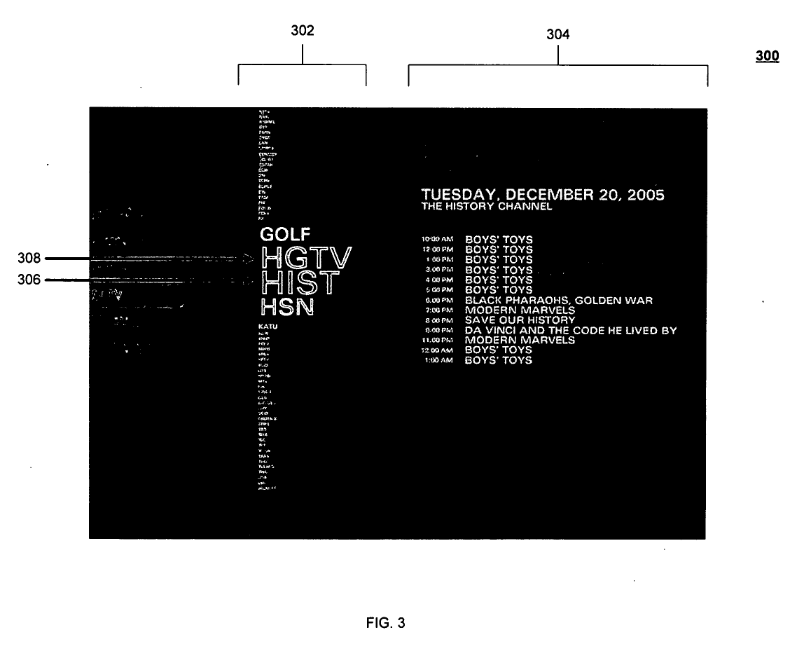

In various embodiments, UIM 208 may include a media lensing module (MLM) 220. Alternatively, MLM 220 may be a separate component from UIM 208. In this case, MLM 220 may include the appropriate interfaces (e.g., API) to communicate information with UIM 208. MLM 220 may implement different software lensing techniques to increase, enlarge or magnify a size for an information object when the pointer coincides with the information object, or the pointer is within a predefined distance from the information object. Software lensing techniques can be performed in one or two dimensions. In the case where the information object comprises text information, for example, software lensing is typically applied in one dimension. MLM 220 may increase a size for the text information when a cursor or pointer coincides or approaches the information object. This may be described in more detail with reference to FIG. 3.

FIG. 3 illustrates one embodiment of a user interface display in a first view. FIG. 3 illustrates a user interface display 300 in a first view. User interface display 300 may provide an example of a GUI display generated by UIM 208. As shown in FIG. 3, user interface display 300 may display a first display column 302 of information objects comprising text information. User interface display 300 may also display a second display column 304 of information objects comprising text information. The information objects of second display column 304 may be associated with, or related to, one or more information objects from first display column 302. It may be appreciated that the various elements of user interface display 300 are provided by way of example only, and more or less elements in different arrangements may be used by UIM 208 and still fall within the intended scope of the embodiments. The embodiments are not limited in this context.

As shown in FIG. 3, first display column 302 may comprise multiple information objects presented in a vertical, stacked or list format. In general, UIM 208 may display a greater number of information objects as the size of each individual information object is decreased, and vice-versa. For example, the information objects of first display column 302 as shown in user interface display 300 may be relatively small. In some cases, for example, the information objects may have a font size that is beyond the visual range of many viewers. First display column 302 may display a relative large number of information objects in first display column 302 in part due to the smaller font size of each individual information object.

As a user moves or navigates a pointer or cursor over information objects 302 using remote control 120, however, MLM 220 may increase the size of an information object relative to the other information objects in first display column 302. As the pointer approaches or coincides with an information object from first display column 302, MLM 220 may increase the font size for the information object thereby making the text information for the information object large enough for viewing by a user in a real time fashion, just as if a magnifying glass were attached to the cursor (e.g., software lensing). MLM 220 may also increase the font size for information objects within a predefined area around the information object of interest, such as adjacent to or near the information object of interest. This may allow a user to read some of the information objects within a certain predefined area around the information object of interest. The size of the surrounding information objects, however, is typically smaller than the size of the information object of interest, thereby allowing a user to more readily discern the information object of interest. In this manner, user interface display 300 may convey a relatively larger amount of information to a viewer via display 110, but only the area of interest plus any surrounding text is large enough to read by a viewer as controlled by the viewer via remote control 120. This may be accomplished while reducing the need for scrolling, paging or indexing operations as implemented by conventional user interfaces.

As a user moves or navigates the cursor over the various information objects of first display column 302, second display column 304 may also display a set of information objects comprising text information. The information objects of second display column 304 may be associated with one or more information objects from first display column 302. For example, if the information objects of first display column 302 comprise network identifiers or channel identifiers for an electronic program guide, then the information objects of second display column 304 may comprise program titles and viewing times for a given channel. Furthermore, the information objects of second display column 304 may be dynamic in nature. Consequently, as a user moves a pointer or cursor to coincide with a given information object of first display column 302, the information objects displayed by second display column 304 may change to reflect new program titles and times associated with the information object of interest. Accordingly, a user may quickly navigate through channels in first display column 302 to ascertain program information presented by second display column 304. Although a first and second display column are presented in user interface display 300 by way of example, it may be appreciated that any number of display columns may be implemented in any number of different hierarchies and still fall within the scope of the embodiments. The embodiments are not limited in this context.

In various embodiments, UIM 208 and MLM 220 may be useful to organize media information for an electronic program guide. To organize “channels” of TV shows it may be desirable to group certain channels together based on network, studio, or other such loose associations. For example, MTV may have a number of channels they produce, so a natural hierarchy can be created that is intuitive for a viewer to use. In this example, first display column 302 may include a list of network identifiers, while second display column 304 may comprise program times and program titles. A viewer may therefore traverse the electronic program guide using a network or channel based hierarchy. In another example, first display column 302 may include a list of program identifiers, while second display column 304 may comprise program times, program titles, program information, and so forth. A viewer may therefore traverse the electronic program guide using a program based hierarchy. The menu hierarchy for an electronic program guide may be organized or ordered by any type of information as desired for a given implementation. The embodiments are not limited in this context.

MLM 220 may allow user UIM 208 to present a large number of options for the electronic program guide on display 110, thereby reducing the need for paging, scrolling or indexing operations. Since there may be hundreds of potential channels available through a given media source, it may be particularly burdensome for a user to view the traditional 5-10 channels in a “TV guide” type grid. To increase the amount of viewing information, each network may be identified by an information object comprising a network logo and accompanying text. The information objects may be ordered in a vertical format. Depending on the initial font size for the information objects, the vertical format may allow UIM 208 to display potentially hundreds of network identifiers in first display column 302. For the viewer to go beyond network identifiers in first display column 302, a standard scrolling technique (e.g., arrow keys) can be used.

As shown in FIG. 3, first display column 302 may include a series of information objects implemented as network identifiers arranged in a vertical format. A viewer may use remote control 120 to control a pointer. UIM 208 may receive movement information for the pointer from remote control 120, and move the pointer on display 110 in accordance with the received movement information. As the viewer moves the pointer over first display column 302, certain network identifiers may increase in size thereby allowing the viewer to better read the network identifier. For example, as the viewer moves the pointer over information object 306 having the text “HIST” to identify the History Television Channel, MLM 220 may increase a font size for the text “HIST” to allow the viewer to better read information object 306. MLM 220 may also change a color for information object 306 to further distinguish information object 306 from the surrounding information objects of first display column 302. MLM 220 may also increase certain information objects adjacent to or nearby information object 306, such as information object 308 having the text “HGTV” to identify the Home & Garden Television Channel and others, for example.

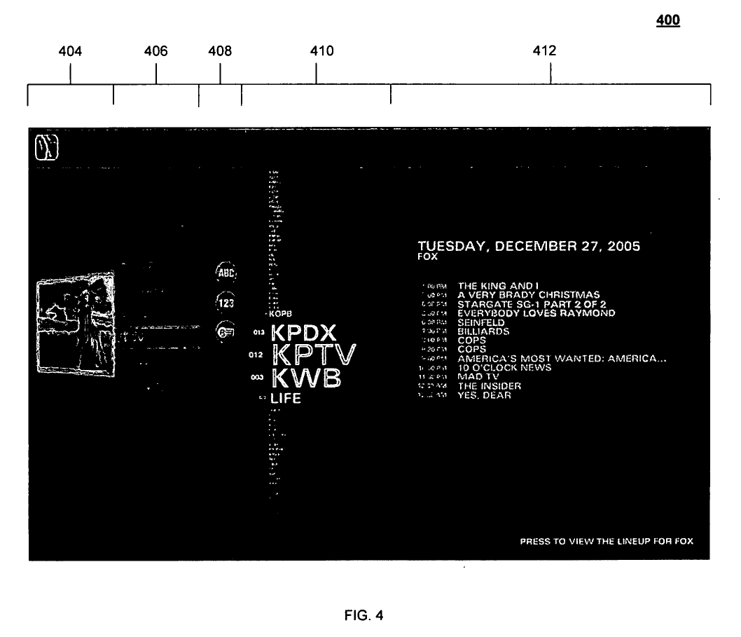

As further shown in FIG. 3, when a viewer moves the pointer to approach or coincide with information object 306 having the HIST identifier, UIM 208 may display a day, data, full name of the channel, and second display column 304 with program times and program titles associated with the HIST identifier. In this manner, a viewer may quickly navigate through the various channels and associated program times and titles, thereby potentially accelerating navigation through the electronic program guide. Further implementation examples for an electronic program guide may be described using FIGS. 4-7.

User interface display 300 provides an example of MLM 220 applied over a display column of network logos with the selected logo showing the next upcoming programming shown as an adjacent display column. Once a viewer has selected a certain network, the viewer may desire to select a television program they would like to view either currently or for recording. The viewer may need to search for a desired program using a current date and possibly several days in advance. A typical “TV Guide” approach is to page through many screens worth of data. To avoid the need to scroll around in the time domain, MLM 220 may use software lensing techniques to quickly display several days worth of programming, and the viewer may use the cursor to read details for a given show without the need for paging or scrolling.

FIG. 4 illustrates one embodiment of a second user interface display in a first view. FIG. 4 illustrates a user interface display 400 in a first view. User interface 400 may comprise another example of a user interface display for an electronic program guide. As shown in FIG. 4, user interface display 400 may include a first display column 404, a second display column 406, a third display column 408, a fourth display column 410, and a fifth display column 412. It may be appreciated that the various elements of user interface display 300 are provided by way of example only, and more or less elements in different arrangements may be used by UIM 208 and still fall within the intended scope of the embodiments. The embodiments are not limited in this context.

User interface display 400 may present electronic program guide information to a viewer using multiple display columns 404-412. The vertical format of each display column 404-412 may allow implementation of a menu hierarchy that moves from left to right, similar to the way a viewer reads text on a printed page. First display column 404 may display an information object representing a picture using image information. Second display column 406 may display a list of information objects representing potential user operations using text information, such as SEARCH ALL, GET MOVIES, GET MUSIC, GET TV, GET GAMES, and GET SERVICE. When a user selects the GET TV category from second display column 406, third display column 408 may display a list of information objects representing electronic program categories using graphic information in the form of symbols or icons. When a user selects the graphical object with the ABC icon, fourth display column 410 may display a list of network/channel identifiers.

UIM 208 may display fourth display column 410 in a manner similar to, for example, first display column 302 as described with reference to FIG. 3. As a user moves or navigates a pointer over the information objects of fourth display column 410, MLM 220 may magnify each network/channel identifier. As the pointer approaches or coincides with the information object titled “KPTV” a fifth display column 412 may display a list of program titles and program times for television shows provided by the network KPTV and its corresponding channels. MLM 220 may magnify the information object KPTV by increasing it to a first size. Similarly, MLM 220 may enlarge a second tier of information objects surrounding the information object titled KPTV, such as the information objects adjacent to KPTV including “KPDX” and “KWB,” for example. MLM 220 may magnify the information objects KPDX and KWB by increasing them to a second size. Typically, the first size is greater than the second size to allow the viewer to better discern the information object of interest from surrounding objects. MLM 220 may continue to enlarge a third tier of information objects surrounding the information object KPTV, such as the information objects adjacent to KPDX and KWB including the information objects “KOPB” and “LIFE,” for example. MLM 220 may continue to enlarge various information objects surrounding the information object of interest to within a predefined area, with the size of the enlarged information objects to generally decrease as a function of distance from the information object of interest.

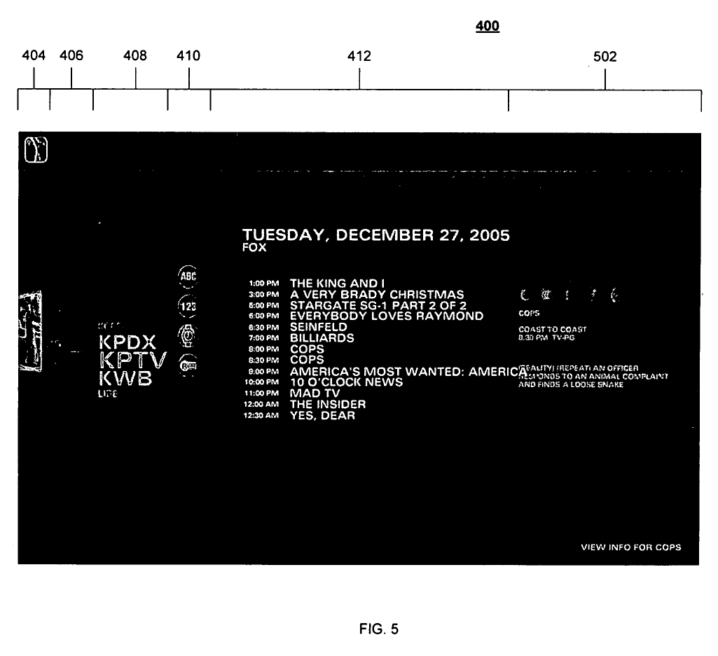

FIG. 5 illustrates one embodiment of a second user interface display in a second view. FIG. 5 illustrates user interface display 400 in a second view. The second view may display multiple display columns similar to display columns 404-412 as described with reference to FIG. 4. In addition to multiple display columns 404-412, the second view may include a sixth display column 502. UIM 208 may use. sixth display column 502 to display program information for a given program identifier. For example, the second view illustrates when a viewer has selected the FOX network KPTV and the viewer is currently looking at the information object having the text information “8:30 PM COPS.” UIM 208 may use sixth display column 502 to provide specific program information for 8:30 PM COPS, such as a show title, more detailed time information, ratings information, show summary, and so forth. In various embodiments, UIM 208 may display the sixth display column 502 in a different viewing layer behind fifth display column 412, with the viewing layer of fifth display column 412 (e.g., foreground layer) having a degree of transparency sufficient to allow a viewer to perceive the information provided by the viewing layer of sixth display column 502 (e.g., background layer).

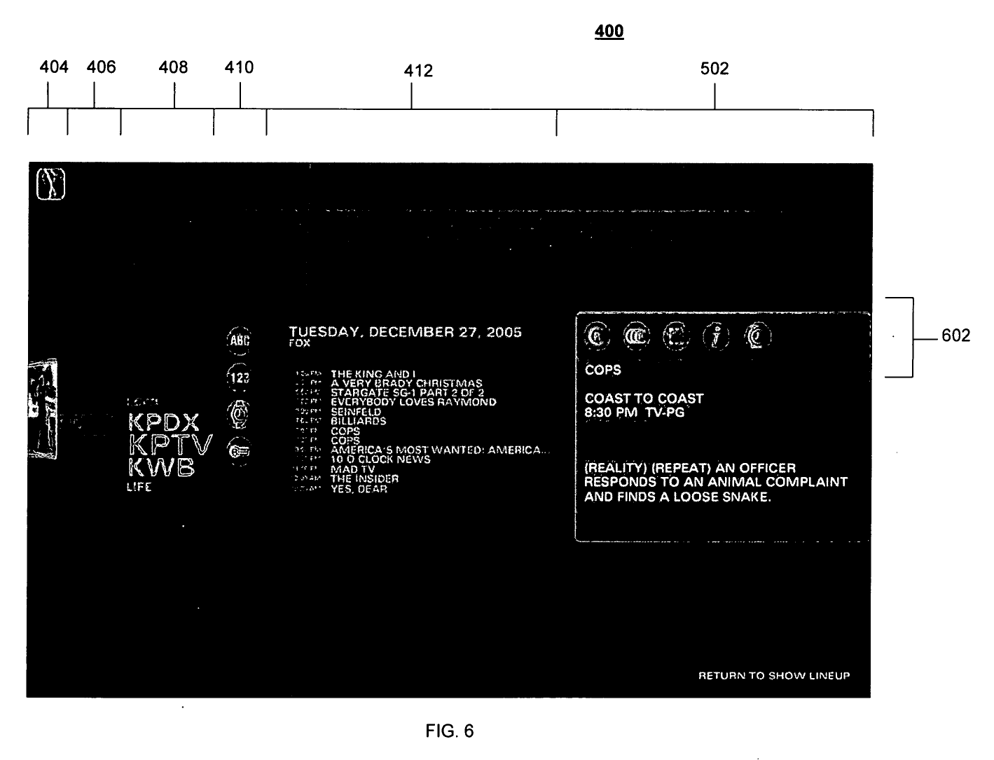

FIG. 6 illustrates one embodiment of a second user interface display in a third view. FIG. 6 illustrates user interface display 400 in a third view. The third view may display multiple display columns similar to display columns 404-412 as described with reference to FIGS. 4 and 5. The third view illustrates user interface display 400 when the viewer has selected the program title 8:30 PM COPS from fifth display column 412. When the viewer selects program title 8:30 PM COPS from fifth display column 412, UIM 208 may move the program information provided by sixth display column 502 to the foreground layer, and move the program titles provided by fifth display column 412 to the background layer, thereby allowing the viewer a better view of the program information. In addition, a number of graphical objects representing recording operations may be provided by display area 602.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

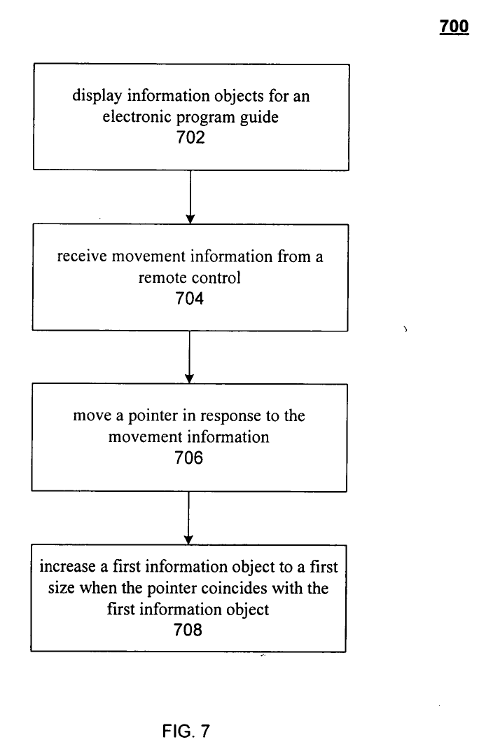

FIG. 7 illustrates one embodiment of a logic flow. FIG. 7 illustrates a logic flow 700. Logic flow 700 may be representative of the operations executed by one or more embodiments described herein, such as media processing node 106, media processing sub-system 108, UIM 208, and/or MLM 220. As shown in logic flow 700, information objects for an electronic program guide may be displayed at block 702. Movement information may be received from a remote control at block 704. A pointer may be moved in response to the movement information at block 706. A first information object may be increased to a first size when the pointer coincides with the first information object at block 708.

In one embodiment, the information objects may be displayed as channel identifiers for the electronic program guide. Program identifiers associated with the first information object may be displayed when the pointer coincides with the first information object. Program information for the program identifiers may be displayed when the pointer coincides with a program identifier. The embodiments are not limited in this context.

In one embodiment, a second information object adjacent to the first information object may be increased to a second size when the pointer coincides with the first information object. The first size may be greater than the second size. The embodiments are not limited in this context.

Graphic Navigation

In addition to performing electronic program guide navigation, UIM 208 and MLM 220 may be used to navigate through various sets of graphical objects. UIM 208 may generate a GUI capable of displaying greater amounts of information to a user, thereby facilitating navigation through the various options available by media processing node 106 and/or media source nodes 102-1-n. The increase in processing capabilities of media devices such as media source nodes 102-1-n and media processing node 106 may also result in an increase in the amount of information needed to be presented to a user. Consequently, UIM 208 may need to provide relatively large volumes of information on display 110. For example, media processing node 106 and/or media source nodes 102-1-n may store large amounts of media information, such as videos, home videos, commercial videos, music, audio play-lists, pictures, photographs, images, documents, electronic guides, and so forth. For a user to select or retrieve media information, UIM 208 may need to display metadata about the media information, such as a title, date, time, size, name, identifier, image, and so forth. In one embodiment, for example, UIM 208 may display the metadata using a number of graphical objects, such as an image. The number of graphical objects, however, may be potentially in the thousands or tens of thousands. To be able to select among such a large set of objects, it may be desirable to convey as many objects as possible on a given screen of display 110. It may also be desirable to avoid scrolling among a large set of menu pages whenever possible.

Various embodiments may be directed to navigating through various sets of graphical objects, such as found in a picture archive (e.g., digital picture album) or video archive (e.g., video on demand, home videos, commercial DVD titles, and so forth). In one embodiment, for example, UIM 208 may be arranged to display a first set of graphical objects of a first size in a first area, and a second set of graphical objects of a second size in a second area when a pointer coincides with said first area. The second set of graphical objects may comprise a sub-set from the first set of graphical objects. The second set of graphical objects may have a second size greater than the first size. MLM 220 may be arranged to increase a first graphical object of the second set of graphical objects to a third size when the pointer coincides with the first graphical object in the second area. The third size may be greater than the second size. In this manner, a user may quickly navigate and select from among a potentially large set of graphical objects.

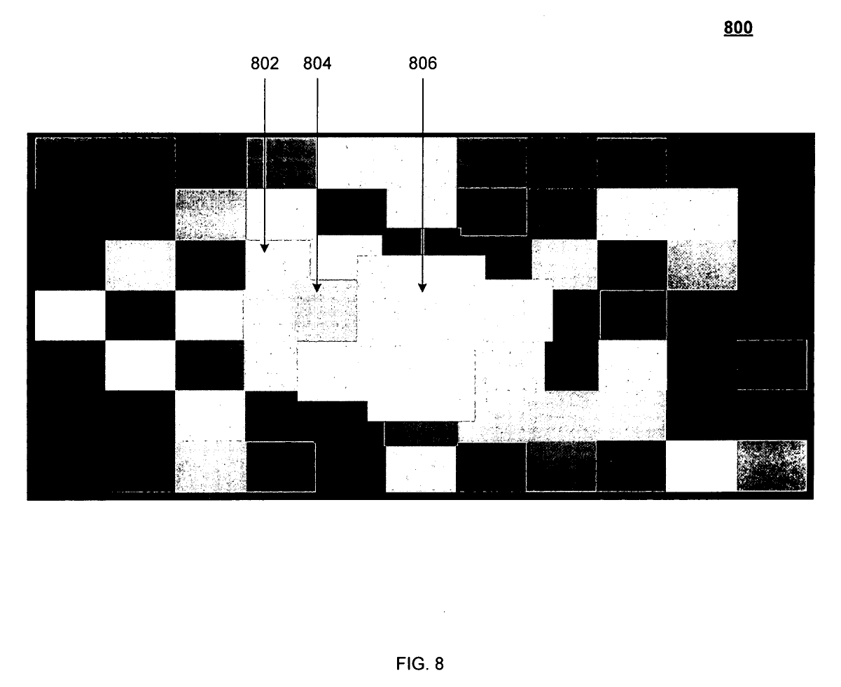

FIG. 8 illustrates one embodiment of a third user interface display. FIG. 8 illustrates a user interface display 800. User interface display 800 may provide an example of a GUI display generated by UIM 208. As shown in FIG. 8, user interface display 800 may display various information objects comprising graphical information (e.g., graphical objects). It may be appreciated that the various elements of user interface display 800 are provided by way of example only, and more or less elements in different arrangements may be used by UIM 208 and still fall within the intended scope of the embodiments. The embodiments are not limited in this context.

In various embodiments, user interface display 800 may display multiple graphical objects. The graphical objects may comprise, for example, a large set of thumbnails to be represented with just enough information to give an idea of the content of an individual thumbnail, but not enough to be certain. A viewer may use remote control 120 to drive a pointer or cursor on display 110. UIM 208 may receive movement information from remote control 120, and move the pointer on display 110 in response to the movement information. When the pointer approaches or coincides with a given thumbnail, MLM 220 may enlarge the thumbnail to show a greater amount of picture details. As shown in FIG. 8, a center graphical object 806 is approximately twice as large as its original size prior to the pointer being moved over it, as represented by graphical object 802. MLM 220 may also begin to enlarge certain graphical objects 804 surrounding graphical object 806, in anticipation of the user moving the pointer over or towards graphical objects 804.

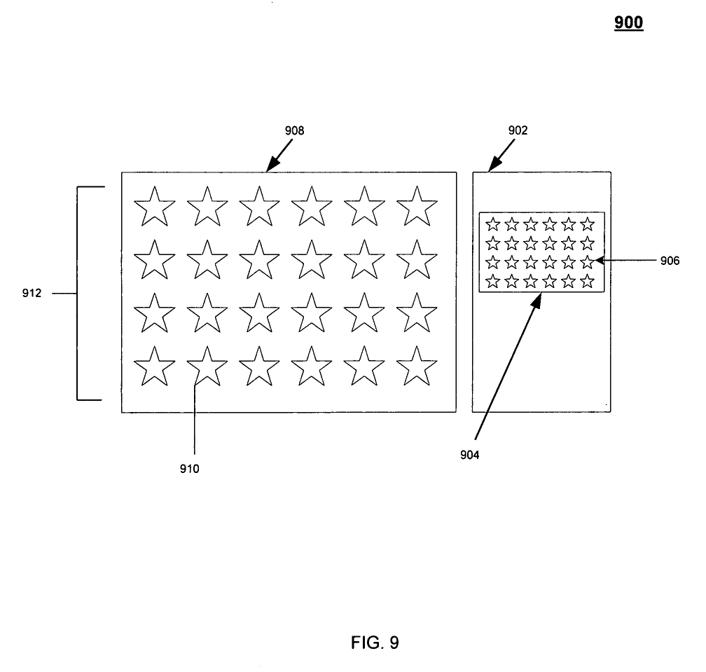

FIG. 9 illustrates one embodiment of a fourth user interface display in a first view. FIG. 9 illustrates a user interface display 900 in a first view. User interface display 900 in the first view illustrates a global situation map for a set of graphical objects represented as a set of stars. At any given time only a relatively small portion of the possible data being perused by a viewer is presented on display 110. The viewer may want to be aware, however, of the rough amount of data that is not immediately visible in detail in order to determine how many more graphical objects are available for possible exploration. User interface display 900 may provide a two or three dimensional global situation map for this purpose. User interface display 900 may be segregated into multiple viewing areas, such as viewing areas 902, 908. Similar to a one dimensional slide-bar, a scroll window 904 can be dragged to allow for a different set of graphical objects 906 from a smaller viewing area 902 to be displayed in a larger viewing area 908. Further, MLM 220 may be used to enlarge a graphical object 910 from graphical objects 912 displayed in viewing area 908. In this manner, a viewer may quickly navigate through a potentially large number of graphical objects.

In one embodiment, for example, UIM 208 may include a first viewing area 902 and a second viewing area 908. UIM 208 may display a first set of graphical objects 906 having a first size in first viewing area 902 of user interface display 900. A particular subset of graphical objects 906 may be framed or selected using a scroll window 904. UIM 208 may display a second set of graphical objects 912 of a second size in second viewing area 908 when a pointer coincides with scroll window 904 of first viewing area 902 in user interface display 900. In one embodiment, for example, the second set of graphical objects 912 may comprise a subset from the first set of graphical objects 906. More particularly, the second set of graphical objects 912 may comprise a subset from the first set of graphical objects 906 currently covered by scroll window 904. Consequently, the second set of graphical objects 912 may dynamically change as a viewer moves scroll window 904 to cover a new subset from the first set of graphical objects 906. The second set of graphical objects 912 may have a second size greater than the first size of graphical objects 906.

A viewer may use the global situation map to become aware of the rough amount of data that is not immediately visible in detail in order to determine how many more graphical objects are available for possible exploration. For example, assume first viewing area 902 includes 60 graphical objects 906 which comprise a total number of objects represented by the global situation map. Further assume scroll window 904 is sized to cover a subset of 24 graphical objects from the 60 original graphical objects at any given time. UIM 208 may display a current set of 24 graphical objects in viewing area 908 which are currently covered by scroll window 904. Conceptually, the viewer may be able to estimate that they are currently viewing approximately one third of the overall possible graphical objects from viewing area 902 in viewing area 908. The viewer may scroll through the remaining graphical objects by moving scroll window 904 up or down. UIM 208 may be arranged to allow the viewer to move scroll window 904 in any desired level of granularity, such as one row at a time, multiple rows at a time, and so forth. The embodiments are not limited in this context.

In various embodiments, MLM 220 may be used to enlarge a graphical object 910 from graphical objects 912 displayed in viewing area 908. MLM 220 may increase a first graphical object 910 of the second set of graphical objects 912 to a third size when the pointer coincides with first graphical object 910 in second viewing area 908. The third size of graphical object 910 may be greater than the second size. MLM 220 may increase a size for graphical object 910 to provide more details of graphical object 910 to the viewer. In this manner, a viewer may determine whether graphical object 910 is the graphical object of interest.

In various embodiments, a user may move scroll window 904 to display a different set of graphical objects 906. The user may move scroll window 904 using remote control 120. As UIM 208 receives movement information from remote control 120, UIM 208 may move scroll window 904 to cover a new set of graphical objects 906 from first viewing area 902. As a new set of graphical objects 906 are covered by scroll window 904, UIM 208 may display the new set of graphical objects 906 in viewing area 908 in enlarged form (e.g., graphical objects 912).

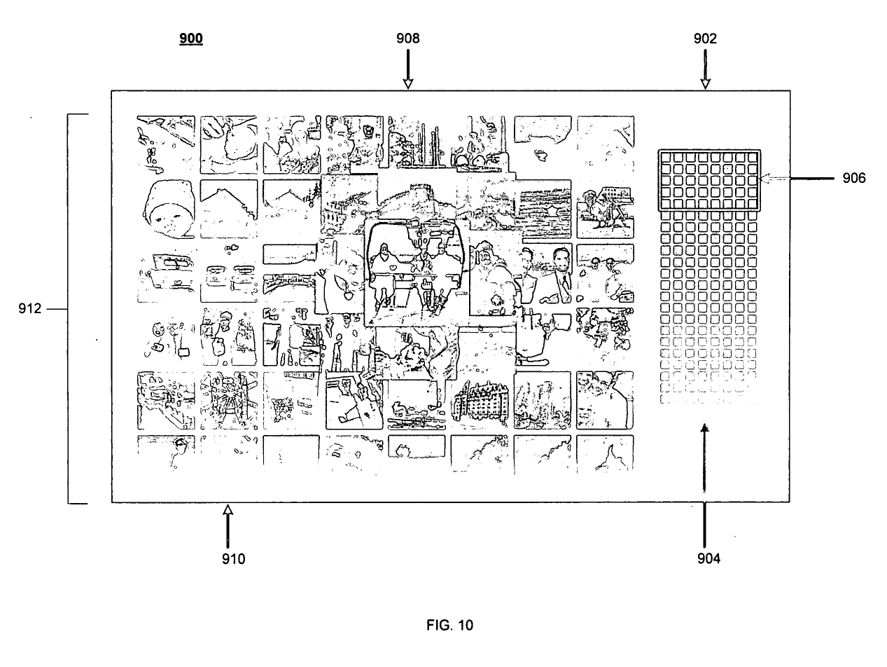

FIG. 10 illustrates one embodiment of a fourth user interface display in a second view. FIG. 10 illustrates a user interface display 900 in a second view. The second view for user interface display 900 is similar to the first view for user interface display 900, except that the graphic stars have been replaced with pictures. The second view of user interface display 900 shows an actual implementation for UIM 208 and MLM 220 combining all of the previously described elements. For example, the second view of user interface display 900 show scroll window 904 in the top right hand comer of the global situation map. This may indicate to a viewer that viewing area 908 includes approximately 20-25% of the total available pictures in viewing area 902. The second view of user interface display 900 also shows a case where MLM 220 has been used to select a particular image. It may be appreciated that the second view of user interface display 900 is only an example, and does not show the extreme limits for a given global situation map. For example, much smaller thumbnails may be used to allow UIM 208 to present even greater amounts of data as desired for a given implementation. The embodiments are not limited in this context.

In various embodiments, UIM 208 may also display metadata associated with a graphical object when the pointer approaches or coincides with the graphical object. For example, assume the graphical object is an image from a video file. UIM 208 may display a title, date and various control buttons to take subsequent actions. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using one or more hardware elements. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Various embodiments may be implemented using one or more software elements. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations. The software may be written or coded using a programming language. Examples of programming languages may include C, C++, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to memory 406. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a user interface module to display information objects for an electronic program guide, receive movement information from a remote control, and move a pointer in response to said movement information; and
a media lensing module to increase a first information object to a first size when said pointer approaches or coincides with said first information object.

2. The apparatus of claim 1, said information objects to comprise channel identifiers for said electronic program guide.

3. The apparatus of claim 1, said user interface module to display program identifiers associated with said first information object when said pointer approaches or coincides with said first information object.

4. The apparatus of claim 1, said user interface module to display program identifiers associated with said first information object when said pointer coincides with said first information object, and program information for said program identifiers when said pointer approaches or coincides with a program identifier.

5. The apparatus of claim 1, said media lensing module to increase a second information object adjacent to said first information object to a second size when said pointer approaches or coincides with said first information object, with said first size greater than said second size.

6. A system, comprising:
a wireless receiver to receive movement information from a remote control;
a user interface module to display information objects for an electronic program guide, receive movement information from said remote control, and move a pointer in response to said movement information; and
a media lensing module to increase a first information object to a first size when said pointer approaches or coincides with said first information object.

7. The system of claim 6, said information objects to comprise channel identifiers for said electronic program guide.

8. The system of claim 6, said user interface module to display program identifiers associated with said first information object when said pointer approaches or coincides with said first information object.

9. The system of claim 6, said user interface module to display program identifiers associated with said first information object when said pointer coincides with said first information object, and program information for said program identifiers when said pointer approaches or coincides with a program identifier.

10. The system of claim 6, said media lensing module to increase a second information object adjacent to said first information object to a second size when said pointer approaches or coincides with said first information object, with said first size greater than said second size.

11. A method, comprising:
displaying information objects for an electronic program guide;
receiving movement information from a remote control;
moving a pointer in response to said movement information; and
increasing a first information object to a first size when said pointer approaches or coincides with said first information object.

12. The method of claim 11, comprising displaying said information objects as channel identifiers for said electronic program guide.

13. The method of claim 11, comprising displaying program identifiers associated with said first information object when said pointer approaches or coincides with said first information object.

14. The method of claim 11, comprising:
displaying program identifiers associated with said first information object when said pointer approaches or coincides with said first information object; and displaying program information for said program identifiers when said pointer approaches or coincides with a program identifier.

15. The method of claim 11, comprising increasing a second information object adjacent to said first information object to a second size when said pointer approaches or coincides with said first information object, with said first size greater than said second size.

16. An article comprising a machine-readable storage medium containing instructions that if executed enable a system to display information objects for an electronic program guide, receive movement information from a remote control, move a pointer in response to said movement information, and increase a first information object to a first size when said pointer approaches or coincides with said first information object.

17. The article of claim 16, further comprising instructions that if executed enable the system to display said information objects as channel identifiers for said electronic program guide.

18. The article of claim 16, further comprising instructions that if executed enable the system to display program identifiers associated with said first information object when said pointer approaches or coincides with said first information object.

19. The article of claim 16, further comprising instructions that if executed enable the system to display program identifiers associated with said first information object when said pointer coincides with said first information object, and display program information for said program identifiers when said pointer approaches or coincides with a program identifier.

20. The article of claim 16, further comprising instructions that if executed enable the system to increase a second information object adjacent to said first information object to a second size when said pointer approaches or coincides with said first information object, with said first size greater than said second size.

21. An apparatus, comprising
a user interface module to display a first set of graphical objects of a first size in a first area, and a second set of graphical objects of a second size in a second area when a pointer approaches or coincides with said first area, with said second set of graphical objects to comprise a sub-set from said first set of graphical objects and with said second size greater than said first size; and
a media lensing module to increase a first graphical object of said second set of graphical objects to a third size when said pointer approaches or coincides with said first graphical object in said second area, with said third size greater than said second size.

22. The apparatus of claim 21, said user interface module to receive movement information from a remote control, and move said pointer in response to said movement information.

23. The apparatus of claim 21, said graphical objects to comprise images.

24. The apparatus of claim 21, said user interface module to display metadata associated with said first graphical object when said pointer approaches or coincides with said first graphical object.

25. The apparatus of claim 21, said media lensing module to increase a second graphical object adjacent to said first graphical object to a fourth size when said pointer approaches or coincides with said first graphical object, with said third size greater than said fourth size.
